(19) United States
(12) Patent Application Publication
(10) Pub. No.: US 2017/0337518 A1
(43) Pub. Date: Nov. 23, 2017

(54) SYSTEMS AND METHODS TO IDENTIFY RESUMES FOR JOB PIPELINES BASED ON SCORING ALGORITHMS

(71) Applicant: Facebook, Inc., Menlo Park, CA (US)

(72) Inventors: Miaoqing Fang, Menlo Park, CA (US); Guven Burc Arpat, Los Altos, CA (US); Jesse William Czelusta, San Francisco, CA (US)

(21) Appl. No.: 15/162,483

(22) Filed: May 23, 2016

(51) Int. Cl. G06Q 10/10; G06N 99/00

(52) U.S. Cl. CPC G06Q 10/1053; G06N 99/005

(57) ABSTRACT

Systems, methods, and non-transitory computer readable media are configured to determine a first score generated by a first scoring algorithm that determines a degree to which a resume is matched to a job pipeline of an organization. A second score generated by a second scoring algorithm that determines a degree to which the resume is matched to the job pipeline is determined. The first score and the second score are processed to generate an aggregate score.

### FIELD OF THE INVENTION

The present technology relates to the field of machine learning. More particularly, the present technology relates to techniques for identifying resumes based on scoring algorithms.

### BACKGROUND

Recruiters can play a primary role in helping organizations locate job candidates. In some cases, a recruiter can proactively seek job candidates for the organization. In other cases, job candidates can initiate contact with an organization through a recruiter of the organization. The process to assess job candidates often can be initiated through electronic receipt by the organization of a resume of a job candidate. An organization can receive large volumes of resumes. The sheer number of resumes received by such an organization can create challenges for the recruiter in vetting the resumes to identify job candidates suited to the organization or a particular job position.

### SUMMARY

Various embodiments of the present technology can include systems, methods, and non-transitory computer readable media configured to determine a first score generated by a first scoring algorithm that determines a degree to which a resume is matched to a job pipeline of an organization. A second score generated by a second scoring algorithm that determines a degree to which the resume is matched to the job pipeline is determined. The first score and the second score are processed to generate an aggregate score.

In an embodiment, the processing of the first score and the second score comprises: generating a first weight associated with the first scoring algorithm; and generating a second weight associated with the second scoring algorithm.

In an embodiment, the first weight and the second weight are based at least in part on associated claimable resume percentages resulting from a manual review process of resumes regarding the accuracy of the first scoring algorithm and the second scoring algorithm.

In an embodiment, the first weight and the second weight are developed using a linear regression technique based on a machine learning model.

In an embodiment, the processing of the first score and the second score comprises: applying the first weight to the first score to generate a first weighted score; and applying the second weight to the second score to generate a second weighted score.

In an embodiment, the processing of the first score and the second score comprises: combining the first weighted score and the second weighted score to generate a relevance score.

In an embodiment, the processing of the first score and the second score comprises: multiplying the relevance score and a goodness score to generate the aggregate score, the goodness score indicating suitability of a job candidate associated with the resume with the organization without regard to the job pipeline.

In an embodiment, an identification of job candidates associated with resumes most suited to the job pipeline based on aggregate scores of the resumes is automatically provided to the recruiter at a regular interval.

In an embodiment, in response to selection by the recruiter of a particular job candidate, detailed information about the job candidate is provided.

In an embodiment, one or more job pipelines best matched with a resume uploaded by the recruiter are determined.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates a system including an example resume determination module, according to an embodiment of the present technology.

FIG. 2 illustrates an example resume scoring module, according to an embodiment of the present technology.

FIG. 3A illustrates an example screen for selection of a job pipeline, according to an embodiment of the present technology.

FIG. 3B illustrates an example electronic communication relating to an identification of job candidates suited to a selected job pipeline, according to an embodiment of the present technology.

FIG. 3C illustrates an example screen to display information about a selected job candidate, according to an embodiment of the present technology.

FIG. 4 illustrates an example screen to identify a job pipeline suited to an uploaded resume, according to an embodiment of the present technology.

FIG. 5A illustrate a first example method to generate an aggregate score reflecting a degree to which a resume is suited to a job pipeline, according to an embodiment of the present technology.

FIGS. 5B-5C illustrate a second example method to generate an aggregate score reflecting a degree to which a resume is suited to a job pipeline, according to an embodiment of the present technology.

FIG. 6 illustrates a network diagram of an example system that can be utilized in various scenarios, according to an embodiment of the present technology.

FIG. 7 illustrates an example of a computer system that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Searching for Resumes Based on Machine Learning Model

As mentioned, recruiters can play a primary role in helping organizations locate job candidates. In some cases, a recruiter can proactively seek job candidates for the organization. In other cases, job candidates can initiate contact with an organization through a recruiter of the organization. The process to assess job candidates often can be initiated through electronic receipt by the organization of a resume of a job candidate. Certain organizations can receive large volumes of resumes. The sheer number of resumes received by such organizations can create challenges for recruiters in vetting the resumes to identify suitable job candidates for a particular job position.

One common challenge confronted by organizations and their recruiters is effectively searching through vast amounts of resume data to match resumes of job candidates with certain job positions of the organization. One conventional technique attempts to address the challenge through use by recruiters of cumbersome keyword searches employing long strings of boolean logic. The searches can reflect efforts by recruiters to comprehensively search through resumes for intended job candidates that satisfy various employment criteria selected by the recruiter. Another conventional technique can involve attempts to automate the assessment of a resume in relation to a job position. In this regard, one or more computer implemented algorithms can provide some quantitative measure regarding suitability of the resume in relation to the job position. However, the algorithms are often rudimentary and perform inaccurate assessments. In addition, different algorithms may provide results about a resume that reflect significant differences in their respective assessments.

An improved approach rooted in computer technology overcomes the foregoing and other disadvantages associated with conventional approaches specifically arising in the realm of computer technology. Systems, methods, and computer readable media of the present technology can employ a plurality of computer implemented algorithms to score resumes in relation to their suitability for various job classifications, such as job pipelines. For each particular algorithm, the resumes can be scored for each job pipeline. In regard to the particular algorithm, top scoring resumes for the job pipeline can be identified. A portion of the top scoring resumes for the job pipeline can be randomly selected. The randomly selected portion of the top scoring resumes can be provided to one or more recruiters. In a manual review phase, the recruiters can identify resumes that are deemed to be suited to the job pipeline. These resumes can be referred to as claimable resumes. A percentage of the resumes provided to the recruiters that the recruiters deem suited to the job pipeline, or claimable resume percentage, can be determined for each algorithm. In one embodiment, the algorithm associated with the largest claimable resume percentage for a particular job pipeline can be used to identify resumes for the job pipeline. In another embodiment, for each resume, the scores determined by the algorithms for the resume can be combined to create an aggregate score for the resume in relation to the job pipeline. In this regard, the scores determined by the algorithms can be combined using weights associated with each algorithm based on a linear regression technique to generate a relevance score for the resume. The weights can be determined in whole or in part based on the claimable resume percentages of the algorithms and based on a machine learning model. A goodness score regarding the general qualifications and credentials reflected in the resume can be determined based on a machine learning model. The relevance score can be multiplied by the goodness score to generate the aggregate score for the resume. In some instances, based on the determination of aggregate scores for the resumes for a job pipeline, the resumes best suited to the job pipeline can be automatically and periodically identified for a recruiter. In other instances, a job pipeline most suited to an uploaded resume can be identified for a recruiter. More details regarding the present technology are described herein.

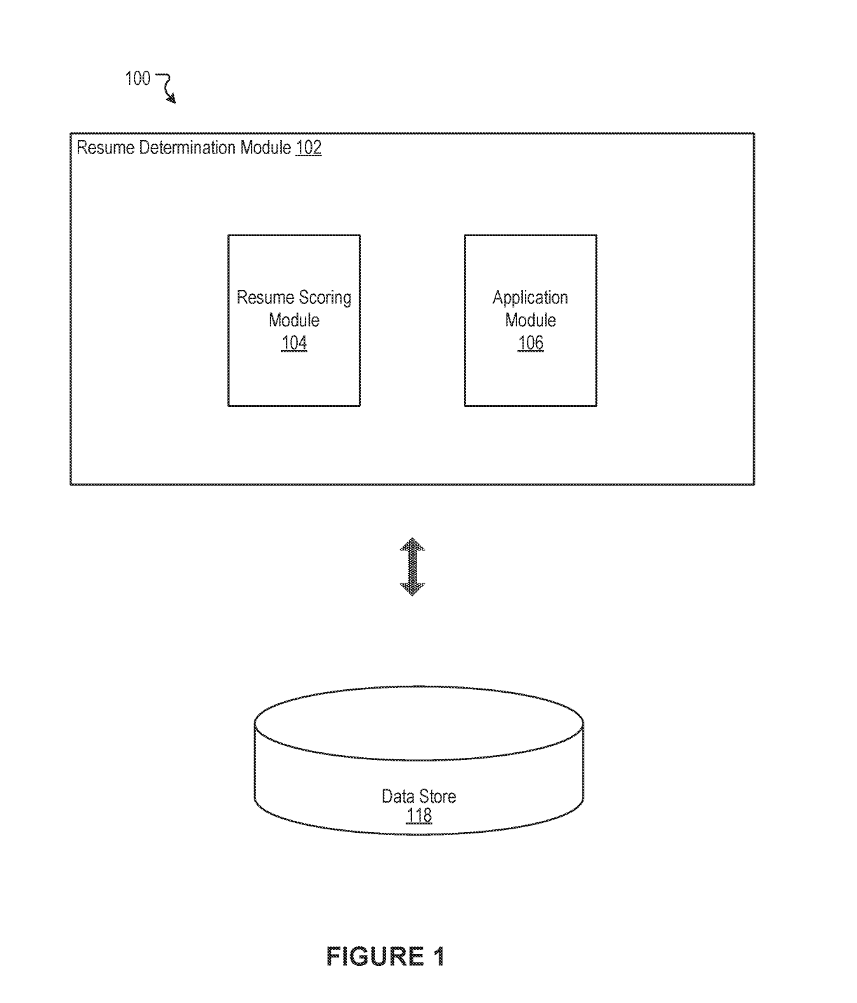

FIG. 1 illustrates an example system 100 including an example resume determination module 102 configured to identify resumes best suited for a job pipeline (or other job classification) for a recruiter for an organization (e.g., a technology company), according to an embodiment of the present technology. Job classifications, as used herein, can refer to terms that span a spectrum between coarse descriptors to fine grained descriptors associated with or otherwise indicative of a job position, responsibility, role, category, department, etc. Reference to a “job pipeline” (or “role”) in connection with embodiments of the present technology can be understood as a relatively fine grained (or specific) descriptor of a job classification. In some embodiments, references to other job classifications, such as a job classification reflecting a relatively coarse grained descriptor (e.g., “department” or “job title”), can be used instead of a job pipeline. An organization can be any entity, such as a company, an establishment, a non-profit, a business, etc. The organization can be of any type or in any industry, such as aerospace and defense, agriculture, automotive, chemicals, construction, consumer goods and services, energy, financial services, firearms, food and beverage, health care, information and technology (e.g., software, hardware, etc.), real estate, manufacturing, mining and drilling, pharmaceuticals and biotechnology, publishing, telecommunications, transportation, etc. While a technology company may be exemplarily discussed in certain contexts for ease of explanation herein, an organization of any industry type or endeavor can be applicable to the present technology. For example, the present technology can be applied to any other type of organization by tailoring the training of machine learning models with features that are relevant to the type of organization and its recruiting strategy.

The resume determination module 102 can include a resume scoring module 104 and an application module 106. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the resume determination module 102 can be implemented in any suitable combinations.

The resume scoring module 104 can generate aggregate scores for resumes based on a plurality of scoring algorithms to determine the suitability of the resumes with a particular job pipeline (e.g., Android software engineer, IOS software engineer, systems software engineer, production software engineer, etc.). Each scoring algorithm can generate a score regarding a degree to which a resume is matched to a particular job pipeline. A weight associated with each score can be applied, and the scores for the resume can be combined to generate a relevance score. The weights can be developed using a manual review process or a linear regression technique based on machine learning. A goodness score, which can represent general eligibility of a job candidate for employment with the organization, can be combined with the relevance score to generate an aggregate score for the resume in relation to the job pipeline. The resume scoring module 104 is discussed in more detail herein.

The application module 106 can determine resumes most suited to a job pipeline based on the aggregate scores of the resumes. The application module 106 can sort the resumes for a job pipeline based on their aggregate scores. A threshold can be determined to select top scoring resumes for the job pipeline. For example, a threshold can be any suitable threshold number of resumes (e.g., 10, 50, 150, etc.). In this regard, the application module 106 can select a count of the highest scoring resumes equal to the threshold number. As another example, a threshold can be a selected threshold score. In this regard, the application module 106 can select the resumes associated with scores equal to or greater than the threshold score.

The application module 106 can perform a variety of functions based on the selected resumes. The functions performed by the application module 106 can significantly streamline and simplify the identification of well suited job candidates for job pipelines of interest. In some embodiments, the application module 106 can provide an appropriate user interface to allow a user, such as a recruiter for an organization, to select one or more job pipelines from a drop down list or from manual entry of a particular job pipeline by the user. The user interface provided by the application module 106 also can allow the user to provide other selection criteria, such as an experience level (e.g., years of experience) of job candidates and geographic considerations (e.g., the location of job pipeline, location of job candidate). For the selected job pipelines, the application module 106 can automatically identify resumes most suited to the selected job pipelines based on the functionality of the resume determination module 102. The application module 106 can perform the identification of such resumes at regular time intervals (e.g., daily, weekly, monthly, etc.) or intermittent times (e.g., on demand). As one example, a threshold number of resumes for a job pipeline selected by a recruiter can be automatically provided by electronic communication (e.g., email) to the recruiter on a daily basis. The electronic communication provided to the user can contain selectable links that, when selected, can navigate the recruiter to a page that displays more information about the job candidates associated with the resumes. Based on information provided by the page, the recruiter can take various actions, such as claiming job candidates, rejecting job candidates, saving records of job candidates, following up with job contacts, or initiating applications of job candidates.

In some embodiments, the application module 106 can provide an appropriate user interface to allow a user, such as a recruiter for an organization, to upload information about a job candidate for a determination of a job pipeline, or related department, most suited to the job candidate. The determination of the job pipeline in this regard can be performed in real time (or near real time). In some instances, the uploaded information about the job candidate can be a resume of the job candidate. In other instances, the information about the job candidate can be profile information about the job candidate, such as information that can be obtained from a job data repository, an online recruiting platform, a social networking system, or other online community maintaining profile information. The application module 106 is discussed in more detail herein.

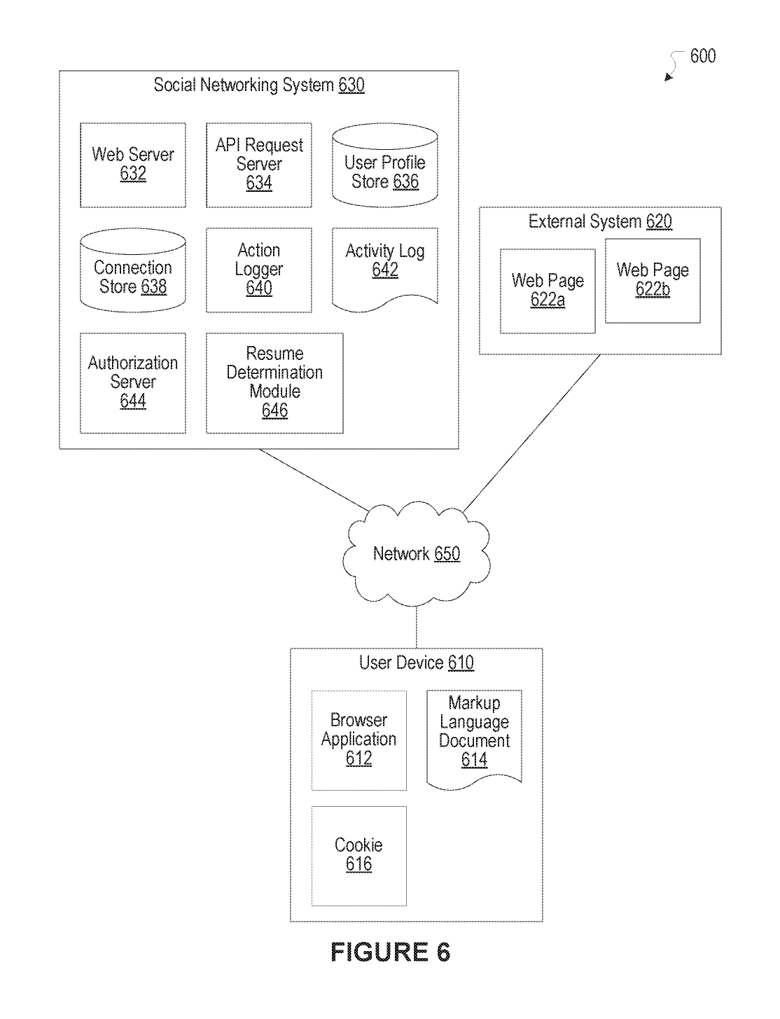

In some embodiments, the resume determination module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the resume determination module 102 can be, in part or in whole, implemented as software running on one or more computing devices or systems, such as on a server or a client computing device. For example, the resume determination module 102 can be, in part or in whole, implemented within or configured to operate in conjunction or be integrated with a social networking system (or service), such as a social networking system 630 of FIG. 6. As another example, the resume determination module 102 can be implemented as or within a dedicated application (e.g., app), a program, or an applet running on a user computing device or client computing system. In some instances, the resume determination module 102 can be, in part or in whole, implemented within or configured to operate in conjunction or be integrated with client computing device, such as a user device 610 of FIG. 6. It should be understood that many variations are possible.

A data store 118 can be configured to store and maintain various types of data, such as the data relating to support of and operation of the resume determination module 102. The data store 118 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the resume determination module 102 can be configured to communicate and/or operate with the data store 118.

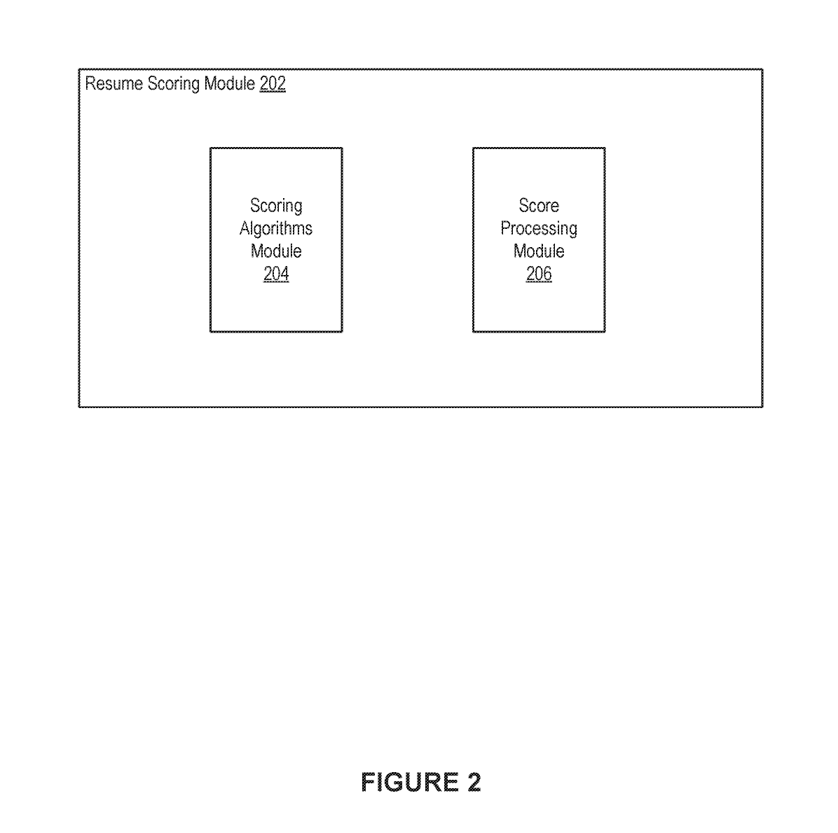

FIG. 2 illustrates an example resume scoring module 202, according to an embodiment of the present technology. In some embodiments, the resume scoring module 104 of FIG. 1 can be implemented with the resume scoring module 202. The resume scoring module 202 can include a scoring algorithms module 204 and a score processing module 206.

The scoring algorithms module 204 can score resumes based on a plurality of scoring algorithms that generate scores indicative of a degree to which resumes are matched to particular job pipelines. The number of resumes can be any suitable number (e.g., two million, 500, etc.). For each particular scoring algorithm, the scoring algorithms module 204 can score the resumes for each job pipeline. For each particular scoring algorithm, top scoring resumes for the job pipeline can be identified. The number of top scoring resumes can be any suitable percentage or number of the resumes (e.g., two percent, 20,000, etc.). A portion of the top scoring resumes for the job pipeline can be selected. In some instances, the portion of the top scoring resumes for the job pipeline can be selected at random. The randomly selected portion of the top scoring resumes can be provided to one or more recruiters.

In a manual review phase, the recruiters can determine, for each scoring algorithm, the resumes that the recruiters deem to be best suited to the job pipeline. These resumes can be referred to as claimable resumes. A percentage of the resumes provided to the recruiters that the recruiters deem best suited to the job pipeline, or claimable resume percentage, can be determined for each scoring algorithm. In one embodiment, only the scoring algorithm associated with the largest claimable resume percentage for a particular job pipeline can be used to identify resumes for the job pipeline. As discussed herein, for the scoring algorithm associated with the largest claimable resume percentage, the application module 106 can identify resumes most suited to a job pipeline based on the aggregate scores of the resumes generated by the scoring algorithm.

The scoring algorithms module 204 can support any suitable scoring algorithms. One example of a scoring algorithm supported by the scoring algorithm module 204 relates to a synonymous search technique. In this regard, resumes can be identified and scored based on their relevance to one or more search terms associated with searches performed by a recruiter. Each search and associated search terms can correspond to a job pipeline. A machine learning model can be trained using terms from a corpus of resumes (or curricula vitae). The model can be based on a technique (e.g., word2vec) that converts the terms into vector representations in a vector space based on meaning of the terms. A set of search terms used by a plurality of recruiters can be represented in the vector space as a set of keywords (or anchor points). When a recruiter wishes to perform one or more searches on a set of resumes, each resume can be converted into an array of values representing a frequency of unique keywords by determining, for each identified chunk of terms in the resume, a nearest keyword. Each array of values representing a frequency of unique keywords can be normalized to reflect the relative importance of the keywords associated with array. Arrays of values representing a frequency of unique keywords for the set of resumes can be rows in a resume matrix. Search terms of the recruiter for each search to be performed can be expressed as an array of values representing a frequency of search terms associated with the search. Arrays of values representing a frequency of search terms associated with various searches can be columns in a job pipeline matrix. A matrix multiplication can be performed for the resume matrix and the job pipeline matrix to generate a score matrix. The resume scores reflected in the score matrix can determine one or more resumes most related to each job pipeline as well as one or more job pipelines to which each resume is most related. Many variations are possible.

Another example of a scoring algorithm supported by the scoring algorithm module 204 relates to a tag space technique. In this regard, a resume corpus based on a large number of resumes can be acquired. Resume tokens from the resume corpus can constitute a training set of data to train a machine learning model. In addition, tags associated with resumes can be included in the training set of data. In some instances, the tags can be manually selected terms relevant to the resume but not expressly included in the resume text itself. The machine learning model can be based on a technique that converts the resume tokens and the tags into vector representations in a vector space based on meaning of the tokens and the tags. One example machine learning model is word2vec. The machine learning model can be used for recommendations of job classifications, such as job pipelines. The machine learning model can be used in an evaluation stage to determine a score that is indicative of a degree to which a resume matches a job pipeline. In this regard, a resume can be represented as an average vector of the vectors representing the tokens and the tags associated with the resume. A particular job pipeline can be represented as an average vector of the vectors representing terms associated with the job pipeline. A distance between the average vector associated with the resume and the average vector associated with the job pipeline can represent a score regarding the suitability of the resume in relation to the job pipeline. Many variations are possible.

Other scoring algorithms that indicate a degree to which a match exists between a resume and a job pipeline can be used in other embodiments. One or more other scoring algorithms other than the scoring algorithm relating to the synonymous search technique and the scoring algorithm relating to the tag space technique can be used by the resume determination module 102. In some embodiments, the resume determination module 102 is agnostic as to the types of scoring algorithms employed.

The score processing module 206 can combine scores determined by a plurality of scoring algorithms to create an aggregate score for a resume in relation to a job pipeline. In some embodiments, two scoring algorithms can be used. In other embodiments, three or more scoring algorithms can be used. In the example of two scoring algorithms, the score processing module 206 can determine a first weight associated with the first scoring algorithm and a second weight associated with the second scoring algorithm. In some embodiments, the first weight and the second weight can be determined based at least in part on the claimable resume percentages associated with the first scoring algorithm and the second scoring algorithm as determined in a manual review phase by recruiters. For example, with respect to a particular job pipeline (e.g., Android SWE), a first weight can be a claimable resume percentage associated with the first scoring algorithm (e.g., 35%) and a second weight can be a claimable resume percentage associated with the second scoring algorithm (e.g., 45%). In some embodiments, the weights can be developed or further refined using a linear regression technique based on a machine learning model. For example, scores generated for a resume by the scoring algorithms can be inputted to the model. The model can be trained through supervised learning based on labels determined from manual review of resumes. The labels can indicate whether each resume is matched to the job pipeline.

The score processing module 206 can apply the first weight to the first score generated by the first scoring algorithm to generate a first weighted score. The score processing module 206 can apply the second weight to the second score generated by the second scoring algorithm to generate a second weighted score. For example, the application of a weight to the score can be multiplication of the weight to the score. The first weighted score and the second weighted score can be summed to generate a relevance score.

The score processing module 206 can generate a goodness score based on a resume to apply to the relevance score for the resume. The goodness score can be indicative of the suitability of a person associated with a resume for employment with an organization without consideration of a specific job pipeline. For example, text of or tags associated with a resume may provide an initial indication that the resume is suited for a particular job pipeline. However, other considerations apart from the text or the tags, which may be reflected by the goodness score, may be indicative of the lack of suitability between the resume and the organization. The goodness score can be determined based on a machine learning model. The model can be trained based on resumes received by the organization. Resumes of persons who were hired by the organization can constitute positive samples for training the model. Resumes of persons who were not hired by the organization can constitute negative samples for training the model. A resume can be applied to the model to generate a goodness score for the resume. The score processing module 206 can multiply the relevance score for the resume in relation to the job pipeline with the goodness score of the resume to generate the aggregate score for the resume.

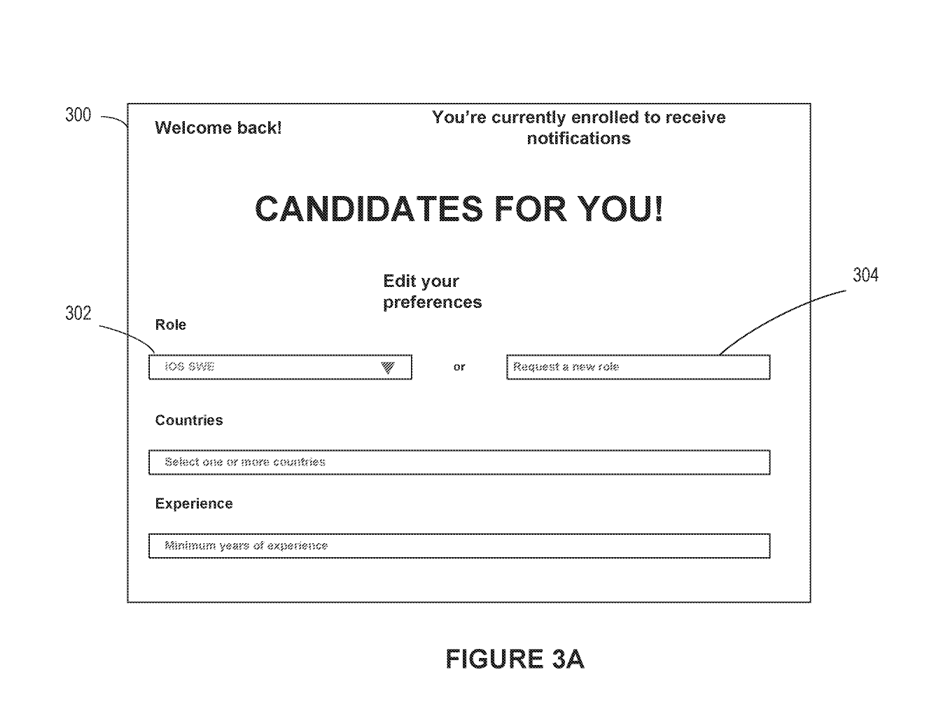

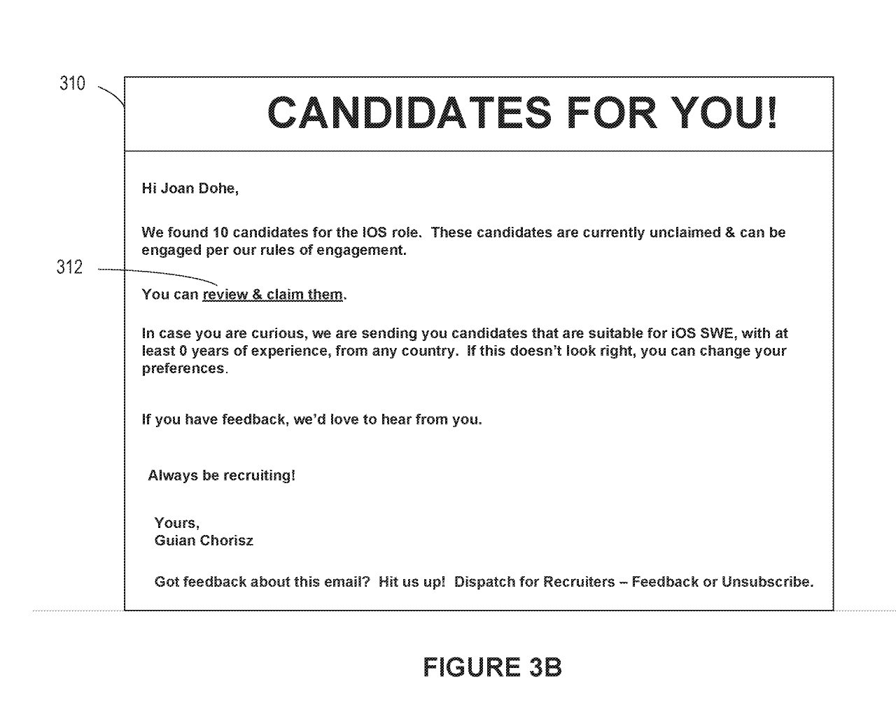

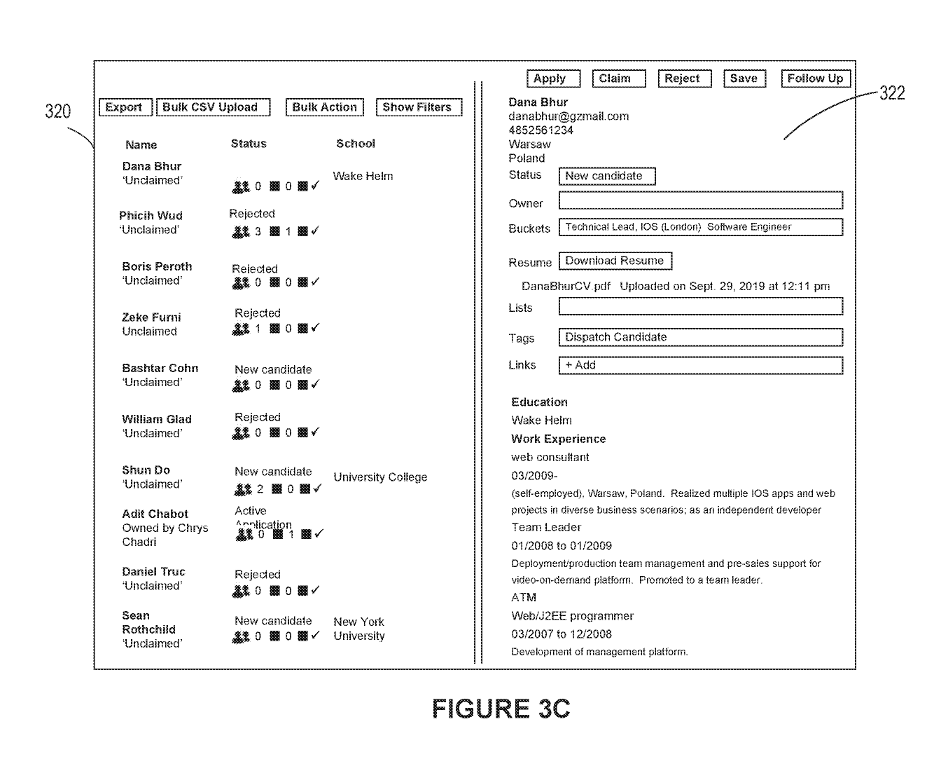

FIG. 3A illustrates an example simplified screen 300 of a user interface, according to an embodiment of the present technology. As shown, the screen 300 is a page for presentation on a computing device, such as a client computing device, of a recruiter for an organization. The screen 300 allows the recruiter to specify preferences for the automatic identification of job candidates that are best suited to one or more selected job pipelines. In the example shown, a drop box 302 allows the recruiter to select a job pipeline (or “role”) in which the recruiter has interest. A text box 304 allows the recruiter to enter a job pipeline that is not included in the drop box 302. In the example shown, the screen 300 also allows the recruiter to select other criteria associated with the resumes to be identified, such as a country of interest and a minimum number of years of experience. Upon provision of the preferences by the recruiter, job candidates associated with resumes that are best suited to the selected job pipeline and the selected criteria are identified.

FIG. 3B illustrates an example simplified screen 310 of a user interface, according to an embodiment of the present technology. The screen 310 reflects an electronic communication automatically delivered to the recruiter and displayed on the computing device of the recruiter. The screen 310 informs the recruiter that job candidates associated with resumes matched to the job pipeline and any other criteria selected by the recruiter have been identified. The screen 310 also provides a link 312 that, when selected, can navigate the recruiter to the identified job candidates for further review by the recruiter. An electronic communication, like the electronic communication reflected in the screen 310, can be delivered to the recruiter at regular intervals, such as daily, to provide new job candidates associated with resumes that are best matched with the job pipeline and any other criteria selected by the recruiter.

FIG. 3C illustrates an example simplified screen 320 of a user interface, according to an embodiment of the present technology. As shown, the screen 320 is a page for presentation on the computing device of the recruiter. The screen 320 provides a listing of job candidates associated with resumes that are matched to the job pipeline and any other criteria selected by the recruiter. In the example shown, a portion 322 of the screen 320 displays detailed information about a particular job candidate in response to selection of the job candidate from the listing. With respect to the selected job candidate, the portion 322 of the screen 320 can allow the recruiter to take various action in connection with the job candidate, such as claiming the job candidate, rejecting the job candidate, saving a record of the job candidate, following up with the job contact, or initiating application of the job candidate.

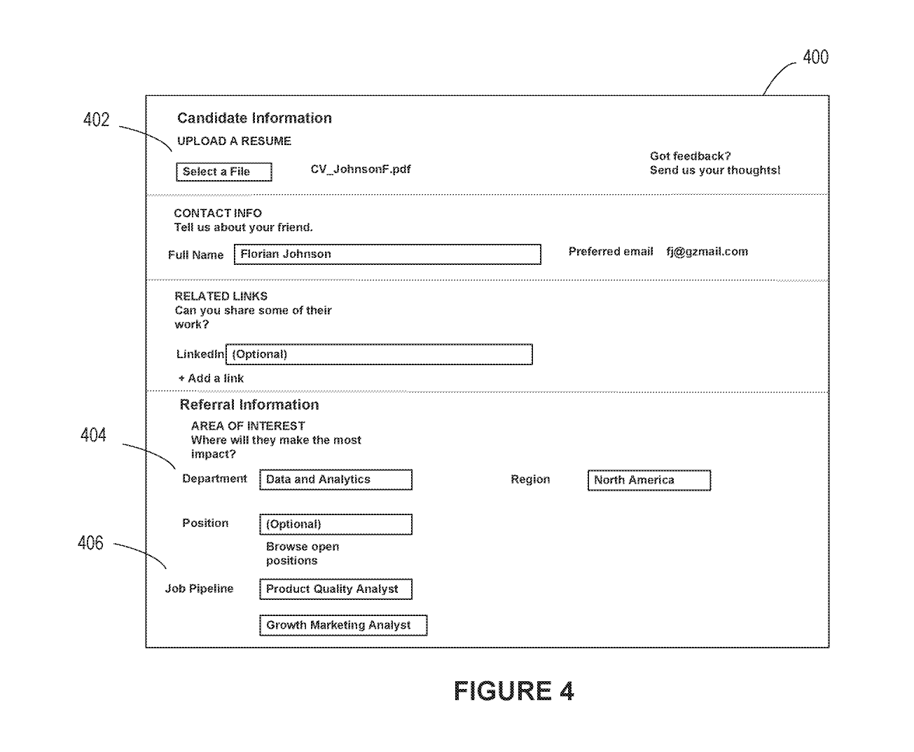

FIG. 4 illustrates an example simplified screen 400 of a user interface, according to an embodiment of the present technology. As shown, the screen 400 is a page for presentation on the computing device of the recruiter. The screen 400 provides a utility 402 that allows the recruiter to select a resume for uploading. The resume can be a resume already provided to the recruiter or an organization of the recruiter. In response to uploading of the resume, one or more job classifications most suited to the uploaded resume can be determined. In the example shown, a section 404 of the screen 400 identifies a relatively coarse grained descriptor relating to a job classification (e.g., a department) most suited to the resume. A section 406 of the screen 400 identifies relatively fine grained descriptors relating to a job classification (e.g., job pipelines) most suited to the resume. As discussed herein, other types of job classifications can be used in other examples. The determined job classifications can be displayed in the screen 400 in real time (or near real time).

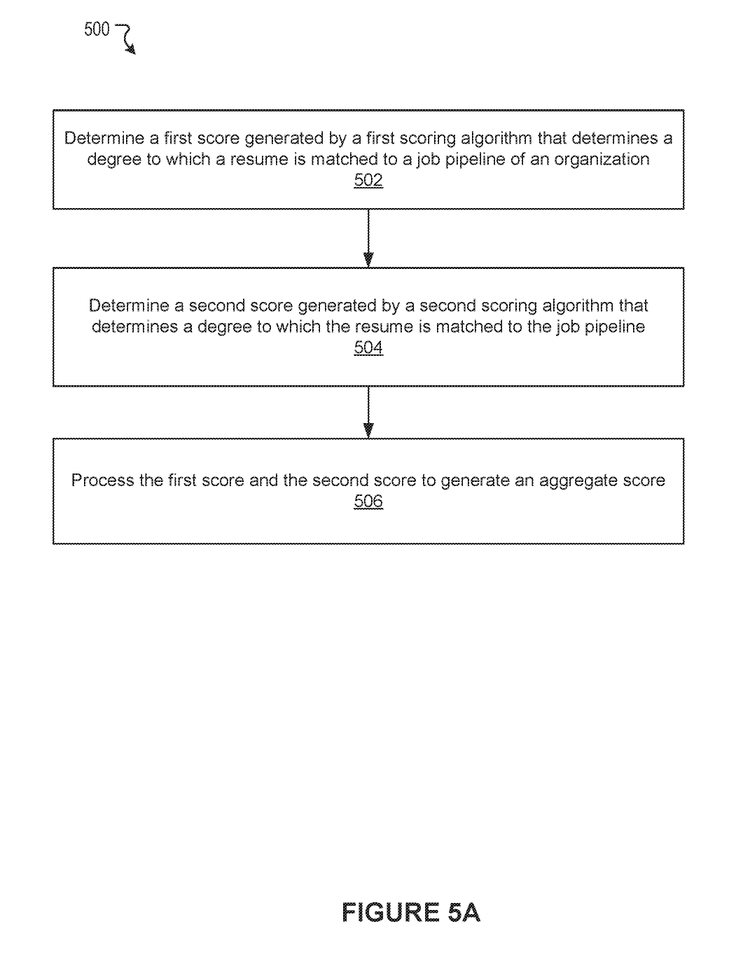

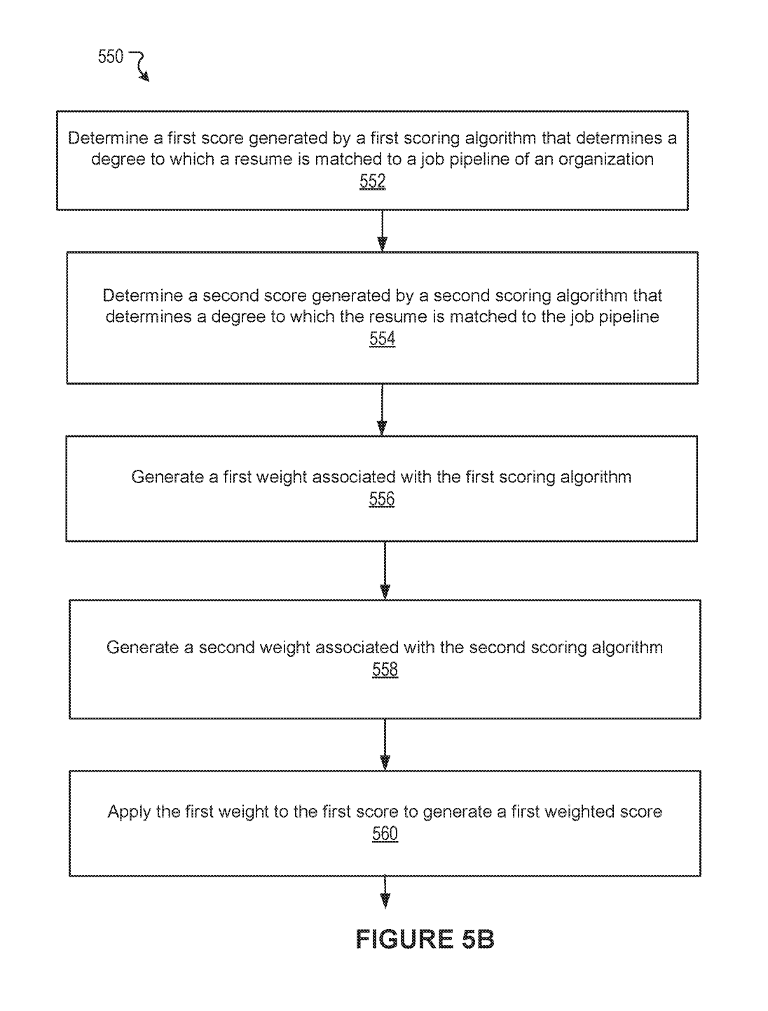

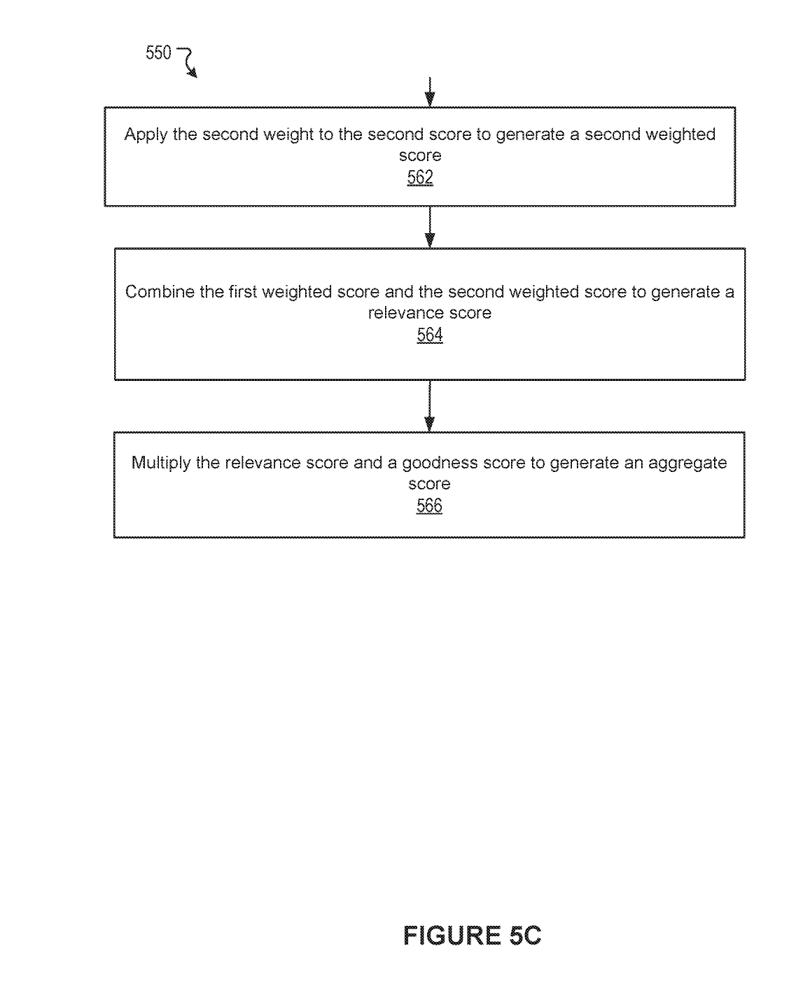

FIG. 5A illustrates a first example method 500 to generate an aggregate score that reflects a degree to which a resume is matched to a job pipeline, according to an embodiment of the present technology. It should be appreciated that there can be additional, fewer, or alternative steps performed in similar or alternative orders, or in parallel, in accordance with the various embodiments and features discussed herein unless otherwise stated.

At block 502, the method 500 can determine a first score generated by a first scoring algorithm that determines a degree to which a resume is matched to a job pipeline of an organization. At block 504, the method 500 can determine a second score generated by a second scoring algorithm that determines a degree to which the resume is matched to the job pipeline. At block 506, the method 500 can process the first score and the second score to generate an aggregate score. Other suitable techniques that incorporate various features and embodiments of the present technology are possible.

FIGS. 5B-5C illustrate a second example method 550 to generate an aggregate score that reflects a degree to which a resume is matched to a job pipeline, according to an embodiment of the present technology. It should be appreciated that there can be additional, fewer, or alternative steps performed in similar or alternative orders, or in parallel, in accordance with the various embodiments and features discussed herein unless otherwise stated.

At block 552, the method 550 can determine a first score generated by a first scoring algorithm that determines a degree to which a resume is matched to a job pipeline of an organization. At block 554, the method 550 can determine a second score generated by a second scoring algorithm that determines a degree to which the resume is matched to the job pipeline. At block 556, the method 550 can generate a first weight associated with the first scoring algorithm. At block 558, the method 550 can generate a second weight associated with the second scoring algorithm. At block 560, the method 550 can apply the first weight to the first score to generate a first weighted score. At block 562, the method 550 can apply the second weight to the second score to generate a second weighted score. At block 564, the method 550 can combine the first weighted score and the second weighted score to generate a relevance score. At block 566, the method 550 can multiply the relevance score and a goodness score to generate an aggregate score. Other suitable techniques that incorporate various features and embodiments of the present technology are possible.

It is contemplated that there can be many other uses, applications, features, possibilities, and variations associated with various embodiments of the present technology. For example, users can choose whether or not to opt-in to utilize the present technology. The present technology also can ensure that various privacy settings, preferences, and configurations are maintained and can prevent private information from being divulged. In another example, various embodiments of the present technology can learn, improve, and be refined over time.

### Social Networking System—Example Implementation

FIG. 6 illustrates a network diagram of an example system 600 that can be utilized in various scenarios, in accordance with an embodiment of the present technology. The system 600 includes one or more user devices 610, one or more external systems 620, a social networking system (or service) 630, and a network 655. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 655. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 655. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 655, which may comprise any combination of local area and/or wide area networks, using wired and/or wireless communication systems.

In one embodiment, the network 655 uses standard communications technologies and protocols. Thus, the network 655 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 655 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 655 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 655. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 655.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 655. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 655, and the API request server 634 receives the API request. The API request server 634 processes the request by calling an API associated with the API request to generate an appropriate response, which the API request server 634 communicates to the external system 620 via the network 655. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a resume determination module 646. The resume determination module 646 can be implemented with the resume determination module 102, as discussed in more detail herein. In some embodiments, one or more functionalities of the resume determination module 646 can be implemented in the user device 610.

### Hardware Implementation

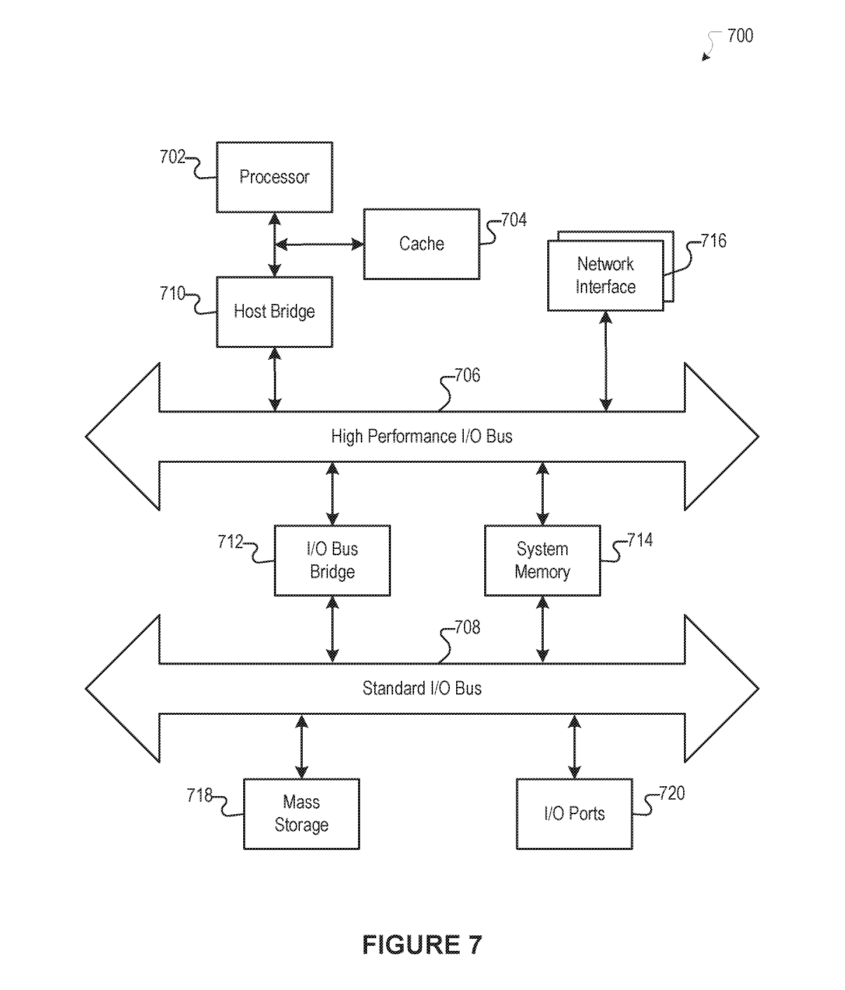

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, a first score generated by a first scoring algorithm that determines a degree to which a resume is matched to a job pipeline of an organization;
determining, by the computing system, a second score generated by a second scoring algorithm that determines a degree to which the resume is matched to the job pipeline; and
processing, by the computing system, the first score and the second score to generate an aggregate score.

2. The computer-implemented method of claim 1, wherein the processing the first score and the second score comprises:
generating a first weight associated with the first scoring algorithm; and
generating a second weight associated with the second scoring algorithm.

3. The computer-implemented method of claim 2, wherein the first weight and the second weight are based at least in part on associated claimable resume percentages resulting from a manual review process of resumes regarding the accuracy of the first scoring algorithm and the second scoring algorithm.

4. The computer-implemented method of claim 2, wherein the first weight and the second weight are developed using a linear regression technique based on a machine learning model.

5. The computer-implemented method of claim 2, wherein the processing the first score and the second score comprises:
applying the first weight to the first score to generate a first weighted score; and
applying the second weight to the second score to generate a second weighted score.

6. The computer-implemented method of claim 5, wherein the processing the first score and the second score comprises:
combining the first weighted score and the second weighted score to generate a relevance score.

7. The computer-implemented method of claim 6, wherein the processing the first score and the second score comprises:
multiplying the relevance score and a goodness score to generate the aggregate score, the goodness score indicating suitability of a job candidate associated with the resume with the organization without regard to the job pipeline.

8. The computer-implemented method of claim 1, further comprising:
automatically providing to the recruiter at a regular interval an identification of job candidates associated with resumes most suited to the job pipeline based on aggregate scores of the resumes.

9. The computer-implemented method of claim 8, further comprising:
in response to selection by the recruiter of a particular job candidate, providing detailed information about the job candidate.

10. The computer-implemented method of claim 1, further comprising:
determining one or more job pipelines best matched with a resume uploaded by the recruiter.

11. A system comprising:
at least one processor; and
a memory storing instructions that, when executed by the at least one processor, cause the system to perform:
determining a first score generated by a first scoring algorithm that determines a degree to which a resume is matched to a job pipeline of an organization;
determining a second score generated by a second scoring algorithm that determines a degree to which the resume is matched to the job pipeline; and
processing the first score and the second score to generate an aggregate score.

12. The system of claim 11, wherein the processing the first score and the second score comprises:
generating a first weight associated with the first scoring algorithm; and
generating a second weight associated with the second scoring algorithm.

13. The system of claim 12, wherein the first weight and the second weight are based at least in part on associated claimable resume percentages resulting from a manual review process of resumes regarding the accuracy of the first scoring algorithm and the second scoring algorithm.

14. The system of claim 12, wherein the first weight and the second weight are developed using a linear regression technique based on a machine learning model.

15. The system of claim 12, wherein the processing the first score and the second score comprises:
applying the first weight to the first score to generate a first weighted score; and
applying the second weight to the second score to generate a second weighted score.

16. A non-transitory computer-readable storage medium including instructions that, when executed by at least one processor of a computing system, cause the computing system to perform a method comprising:
determining a first score generated by a first scoring algorithm that determines a degree to which a resume is matched to a job pipeline of an organization;
determining a second score generated by a second scoring algorithm that determines a degree to which the resume is matched to the job pipeline; and
processing the first score and the second score to generate an aggregate score.

17. The non-transitory computer-readable storage medium of claim 16, wherein the processing the first score and the second score comprises:
generating a first weight associated with the first scoring algorithm; and
generating a second weight associated with the second scoring algorithm.

18. The non-transitory computer-readable storage medium of claim 17, wherein the first weight and the second weight are based at least in part on associated claimable resume percentages resulting from a manual review process of resumes regarding the accuracy of the first scoring algorithm and the second scoring algorithm.

19. The non-transitory computer-readable storage medium of claim 17, wherein the first weight and the second weight are developed using a linear regression technique based on a machine learning model.

20. The non-transitory computer-readable storage medium of claim 17, wherein the processing the first score and the second score comprises:
applying the first weight to the first score to generate a first weighted score; and
applying the second weight to the second score to generate a second weighted score.
